(19) United States
(12) Patent Application Publication
(10) Pub. No.: US 2022/0308479 A1
(43) Pub. Date: Sep. 29, 2022

(54) PREPARING METHOD OF ELECTROSTATIC CHARGE IMAGE DEVELOPING TONER, ELECTROSTATIC CHARGE IMAGE DEVELOPING TONER, AND ELECTROSTATIC CHARGE IMAGE DEVELOPER

(71) Applicant: FUJIFILM Business Innovation Corp., Tokyo (JP)

(72) Inventors: Atsushi SUGAWARA, Kanagawa (JP); Daisuke NOGUCHI, Kanagawa (JP); Kazuhiko NAKAMURA, Kanagawa (JP); Hiroshi NAKAZAWA, Kanagawa (JP)

(73) Assignee: FUJIFILM Business Innovation Corp., Tokyo (JP)

(21) Appl. No.: 17/375,103

(22) Filed: Jul. 14, 2021

(30) Foreign Application Priority Data
Mar. 23, 2021 (JP) 2021-049116

(51) Int. Cl. G03G 9/08

(52) U.S. Cl. CPC G03G 9/0804

(57) ABSTRACT

A preparing method of an electrostatic charge image developing toner includes: mixing an amorphous resin particle dispersion containing amorphous resin particles and a crystalline resin particle dispersion containing crystalline resin particles to prepare a mixed dispersion containing the amorphous resin particles and the crystalline resin particles; aggregating the amorphous resin particles and the crystalline resin particles in the mixed dispersion to form aggregated particles; and coalescing the aggregated particles by heating a dispersion containing the aggregated particles to form toner particles, in which both a zeta potential of the amorphous resin particle dispersion and a zeta potential of the crystalline resin particle dispersion are negative values, and an absolute value of the zeta potential of the crystalline resin particle dispersion is smaller than an absolute value of the zeta potential of the amorphous resin particle dispersion.

### CROSS-REFERENCE TO RELATED APPLICATIONS

This application is based on and claims priority under 35 USC 119 from Japanese Patent Application No. 2021-049116 filed on Mar. 23, 2021.

### BACKGROUND

### (i) Technical Field

The present disclosure relates to a preparing method of an electrostatic charge image developing toner, an electrostatic charge image developing toner, and electrostatic charge image developer.

### (ii) Related Art

JP2002-333737A discloses a preparing method of a toner, including a step of aggregating coloring agent particles and at least two kinds of polymer primary particles under a condition of a pH of 2 to 7 to obtain a particle aggregate, in which an absolute value of a zeta potential of a first polymer primary particles is 5 to 30 mV and an absolute value of a zeta potential of a second polymer primary particles is 30 to 100 mV.

JP2005-140987A discloses a preparing method of a toner at least containing a coloring agent and a binder resin having a crystalline resin as a main component, the method including: an aggregating step of mixing and aggregating a resin particle dispersion which contains at least dispersed particles of a crystalline resin having a carboxylic acid group and has properties of a pH of 6.0 or more and 10.0 or less and a zeta potential of −60 mV or more and −30 mV or less and a coloring agent particle dispersion which has dispersed particles of a coloring agent to obtain an aggregated particle dispersion in which aggregated particles in which particles of the crystalline resin and particles of the coloring agent are mixed are dispersed; and a coalescing step of heating and coalescing the aggregated particle dispersion to obtain toner particles.

JP2011-128574A discloses a preparing method of a developer, the method including: a step of preparing a toner material dispersion by mixing a granular mixture containing a binder resin and a coloring agent and an aqueous medium; a step of subjecting the toner material dispersion to mechanical shearing to make a granular mixture finer to prepare a dispersion containing fine particles having a particle size smaller than a particle size of the granular mixture; and a step of forming aggregated particles by aggregating fine particles by adjusting a pH of a dispersion containing fine particles, in which in the step of forming aggregated particles, particles in the dispersion have a volume average particle diameter of 2 μm or less at pH 7, and a pH in the dispersion is 3.0 to 6.9 when a zeta potential of the particles is −30 mV.

### SUMMARY

Aspects of non-limiting exemplary embodiments of the present disclosure relate to a preparing method of an electrostatic charge image developing toner, the method being capable of preparing an electrostatic charge image developing toner that prevents gloss unevenness in an image from being generated, compared to a case where an absolute value of a zeta potential of a crystalline resin particle dispersion is larger than an absolute value of a zeta potential of an amorphous resin particle dispersion.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a preparing method of an electrostatic charge image developing toner, the method including:

mixing an amorphous resin particle dispersion containing amorphous resin particles and a crystalline resin particle dispersion containing crystalline resin particles to prepare a mixed dispersion containing the amorphous resin particles and the crystalline resin particles;

aggregating the amorphous resin particles and the crystalline resin particles in the mixed dispersion to form aggregated particles; and

coalescing the aggregated particles by heating a dispersion containing the aggregated particles to form toner particles,

wherein both a zeta potential of the amorphous resin particle dispersion and a zeta potential of the crystalline resin particle dispersion are negative values, and

an absolute value of the zeta potential of the crystalline resin particle dispersion is smaller than an absolute value of the zeta potential of the amorphous resin particle dispersion.

### DETAILED DESCRIPTION

Hereinafter, exemplary embodiments of the present disclosure will be described. These descriptions and examples illustrate exemplary embodiments and do not limit the scope of the exemplary embodiments.

The numerical range indicated by using “to” in the present disclosure indicates a range including the numerical values before and after “to” as the minimum value and the maximum value, respectively.

In a numerical range described in steps in the present disclosure, an upper limit or a lower limit described in one numerical range may be replaced with an upper limit or a lower limit of another numerical range described in steps. Further, in the numerical range described in the present disclosure, the upper limit or the lower limit on the numerical range may be replaced with the value described in examples.

In the present disclosure, the term “step” includes not only an independent step but also other steps as long as the intended purpose of the step is achieved even if it is not able to be clearly distinguished from other steps.

In the present disclosure, each component may contain plural kinds of applicable substances. When referring to the amount of each component in a composition in the present disclosure, in a case where there are plural kinds of substances corresponding to each component in the composition, the amount of each component in the composition means a total amount of the plural kinds of substances present in the composition, unless otherwise specified.

In the present disclosure, plural kinds of particles corresponding to each component may be contained. In a case where there are plural kinds of particles corresponding to each component in a composition, a particle diameter of each component means a value in a mixture of the plural kinds of particles present in the composition, unless otherwise specified.

In the present disclosure, “(meth)acrylic” means at least one of acrylic or methacrylic, and “(meth)acrylate” means at least one of acrylate or methacrylate.

In the present disclosure, a “toner” refers to an “electrostatic charge image developing toner”, a “developer” refers to an “electrostatic charge image developer”, and a “carrier” refers to a “electrostatic charge image carrier”.

In the present disclosure, a method for preparing a toner particle by aggregating and coalescing material particles in a solvent is referred to as an emulsion aggregation (EA) method.

<Preparing Method of Electrostatic Charge Image Developing Toner>

The preparing method of a toner according to the exemplary embodiment is a preparing method of a toner including preparing toner particles by the EA method, and has the following mixing step, aggregating step, and coalescing step.

Mixing step: A step of mixing an amorphous resin particle dispersion containing amorphous resin particles and a crystalline resin particle dispersion containing crystalline resin particles to prepare a mixed dispersion containing the amorphous resin particles and the crystalline resin particles.

Aggregating step: A step of aggregating the amorphous resin particles and the crystalline resin particles in the mixed dispersion to form aggregated particles.

Coalescing step: A step of coalescing the aggregated particles by heating a dispersion containing the aggregated particles to form toner particles.

In the preparing method of a toner according to the exemplary embodiment, both a zeta potential of the amorphous resin particle dispersion and a zeta potential of the crystalline resin particle dispersion are negative values, and an absolute value of the zeta potential of the crystalline resin particle dispersion is smaller than an absolute value of the zeta potential of the amorphous resin particle dispersion.

In a case where plural types of amorphous resin particle dispersions are prepared, the amorphous resin particle dispersion having the largest amount of resin brought into the mixed dispersion may satisfy the requirements.

In a case where plural types of crystalline resin particle dispersions are prepared, the crystalline resin particle dispersion having the largest amount of resin brought into the mixed dispersion may satisfy the requirements.

The toner prepared by the preparing method of a toner according to the exemplary embodiment prevents gloss unevenness in an image from being generated. The following is presumed as the mechanism.

It is known that a crystalline resin is added to a toner for the purpose of preventing the gloss unevenness in an image from being generated. In order to more effectively prevent the gloss unevenness from being generated, the crystalline resin may be present in the vicinity of a toner surface.

However, in a toner preparing method in which material particles of a toner are aggregated in a solvent and then coalesced, plural kinds of material particles tend to be more likely to be mixed with each other as the difference in surface potential of the particles is smaller.

In the preparing method according to the exemplary embodiment, a difference in the zeta potential between the amorphous resin particle dispersion and the crystalline resin particle dispersion which are provided for toner preparing is provided, and the absolute value of the zeta potential of the crystalline resin particle dispersion is smaller than the absolute value of the zeta potential of the amorphous resin particle dispersion. Accordingly, a disposition of the crystalline resin particles in the aggregated particles is set near the surface. Even in the finished toner, since the crystalline resin particles are present in the vicinity of the toner surface, the gloss unevenness may be efficiently prevented from being generated.

In the exemplary embodiment, the zeta potentials of the amorphous resin particle dispersion, the crystalline resin particle dispersion, and the release agent particle dispersion are measured by an electrophoresis method (also referred to as a laser Doppler method). A measuring device is, for example, a zeta potential measuring system ELSZ-2000Z or ELSZ-2000ZS manufactured by Otsuka Electronics Co., Ltd.

A part of the particle dispersion is taken and used as a measurement sample without dilution and without adjusting the pH. A liquid temperature of the measurement sample at the time of measurement is 25° C.

In the exemplary embodiment, “crystalline” of the resin means that a resin has a clear endothermic peak instead of a stepwise endothermic change in differential scanning calorimetry (DSC), and specifically, a half width of an endothermic peak when measured at a heating rate of 10° C./min is within 10° C.

In the exemplary embodiment, the “amorphous” of the resin means that the half width exceeds 10° C., a stepwise endothermic change is shown, or a clear endothermic peak is not recognized.

Hereinafter, steps and materials of the preparing method of a toner according to the exemplary embodiment will be described in detail.

[Mixing Step]

The mixing step is a step of mixing at least the amorphous resin particle dispersion and the crystalline resin particle dispersion. In the mixing step, the release agent particle dispersion may be further mixed, and the coloring agent particle dispersion may be further mixed. The order of mixing these particle dispersions is not limited.

The mixed dispersion prepared in the mixing step contains at least amorphous resin particles and crystalline resin particles, may further contain release agent particles, and may further contain coloring agent particles.

Hereinafter, what is common to the amorphous resin particle dispersion, the crystalline resin particle dispersion, the release agent particle dispersion, and the coloring agent particle dispersion will be collectively referred to as a “particle dispersion”.

An example of the exemplary embodiment of the particle dispersion is a dispersion in which a material is dispersed in a dispersion medium in the form of particles by a surfactant.

The dispersion medium of the particle dispersion may be an aqueous medium. Examples of the aqueous medium include water and alcohol. The water may be water having a reduced ion content such as distilled water and ion exchanged water. These aqueous media may be used alone, or two or more thereof may be used in combination.

Examples of the surfactant dispersing the material in the dispersion medium include anionic surfactants such as sulfate ester, sulfonate, phosphoric acid ester, and soap anionic surfactants; cationic surfactants such as amine salt and quaternary ammonium salt cationic surfactants; and nonionic surfactants such as polyethylene glycol, alkyl phenol ethylene oxide adduct, and polyhydric alcohol nonionic surfactants. The surfactants may be used alone, or two or more thereof may be used in combination. Nonionic surfactants may be used in combination with anionic surfactants or cationic surfactants.

Examples of a method of dispersing the material in the dispersion medium in the form of particles include a common dispersing method using a rotary shearing-type homogenizer, or a ball mill, a sand mill, or a Dyno mill as media.

Examples of the method of dispersing the resin in the dispersion medium in the form of particles include a phase inversion emulsification method. The phase inversion emulsification method includes: dissolving a resin in a hydrophobic organic solvent in which the resin is soluble; conducting neutralization by adding a base to an organic continuous phase (O phase); and performing phase inversion from W/O to O/W by adding an aqueous medium (W phase), thereby dispersing the resin as particles in the aqueous medium.

A volume average particle diameter of the particles dispersed in the particle dispersion may be 30 nm or more and 300 nm or less, preferably 50 nm or more and 250 nm or less, and more preferably 80 nm or more and 200 nm or less.

The volume average particle diameter of the particles in the particle dispersion refers to a particle diameter when the cumulative percentage becomes 50% from the small diameter side in a particle size distribution measured by a laser diffraction-type particle size distribution measuring device (for example, manufactured by Horiba, Ltd., LA-700).

The content of the particles contained in the particle dispersion may be, for example, 5% by weight or more and 50% by weight or less, preferably 10% by weight or more and 40% by weight or less, and more preferably 15% by weight or more and 30% by weight or less.

A difference D1 between a value of the zeta potential of the amorphous resin particle dispersion and a value of the zeta potential of the crystalline resin particle dispersion may be 10 mV or more and 50 mV or less, preferably 15 mV or more and 45 mV or less, and more preferably 20 mV or more and 40 mV or less, from the viewpoint that the disposition of the crystalline resin particles in the aggregated particles is near the surface of the aggregated particles.

In a case where plural types of amorphous resin particle dispersions are prepared, the amorphous resin particle dispersion having the largest amount of resin brought into the mixed dispersion may satisfy the requirements.

In a case where plural types of crystalline resin particle dispersions are prepared, the crystalline resin particle dispersion having the largest amount of resin brought into the mixed dispersion may satisfy the requirements.

The difference between the value of the zeta potential of the amorphous polyester resin particle dispersion and the value of the zeta potential of the crystalline polyester resin particle dispersion may also be in the range.

The value of the zeta potential of the amorphous resin particle dispersion may be −70 mV or more and −30 mV or less, preferably −65 mV or more and −40 mV or less, and still preferably −60 mV or more and −45 mV or less, from the viewpoint of dispersion stability of the amorphous resin particles in the amorphous resin particle dispersion and the mixed dispersion.

The value of the zeta potential of the amorphous polyester resin particle dispersion may also be in the range.

The zeta potential of the amorphous resin particle dispersion is controlled by, for example, a kind of a polymerization component of the amorphous resin and a kind and the amount of the surfactant contained in the amorphous resin particle dispersion.

The value of the zeta potential of the crystalline resin particle dispersion may be −30 mV or more and −10 mV or less, preferably −30 mV or more and −15 mV or less, and more preferably −30 mV or more and −20 mV or less, from the viewpoint of the dispersion stability of the crystalline resin particles in the crystalline resin particle dispersion and the mixed dispersion and the viewpoint that the disposition of the crystalline resin particles in the aggregated particles is near the surface of the aggregated particles.

The value of the zeta potential of the crystalline polyester resin particle dispersion may also be in the range.

The zeta potential of the crystalline resin particle dispersion is controlled by, for example, a kind of a polymerization component of the crystalline resin and a kind and the amount of the surfactant contained in the crystalline resin particle dispersion.

—Amorphous Resin—

The amorphous resin may be an amorphous polyester resin.

Note that, as the amorphous polyester resin, a commercially available product may be used, or a synthetic product may be used.

Examples of the amorphous polyester resin include a condensation polymer of polyvalent carboxylic acid and polyhydric alcohol.

Examples of the polyvalent carboxylic acid which is a polymerization component of the amorphous polyester resin include aliphatic dicarboxylic acids (for example, oxalic acid, malonic acid, maleic acid, fumaric acid, citraconic acid, itaconic acid, glutaconic acid, succinic acid, alkenylsuccinic acid, adipic acid, and sebacic acid), alicyclic dicarboxylic acids (for example, cyclohexanedicarboxylic acid), aromatic dicarboxylic acids (for example, terephthalic acid, isophthalic acid, phthalic acid, and naphthalenedicarboxylic acid), anhydrides thereof, or lower (for example, 1 or more to 5 or less carbon atoms) alkyl esters thereof. Among these, as the polyvalent carboxylic acid, for example, aromatic dicarboxylic acid is preferable.

The polyvalent carboxylic acid may be used in combination with dicarboxylic acid and trivalent or higher carboxylic acid having a crosslinked structure or a branched structure. Examples of the trivalent or higher carboxylic acid include trimellitic acid, pyromellitic acid, anhydrides thereof, and lower (for example, 1 or more to 5 or less carbon atoms) alkyl esters thereof.

These polyvalent carboxylic acids may be used alone, or two or more thereof may be used in combination.

Examples of polyhydric alcohols which is the polymerization component of the amorphous polyester resin include aliphatic diols (for example, ethylene glycol, diethylene glycol, triethylene glycol, propylene glycol, butanediol, hexanediol, and neopentyl glycol), alicyclic diols (for example, cyclohexanediol, cyclohexanedimethanol, and hydrogenated bisphenol A), and aromatic diols (for example, a bisphenol A ethylene oxide adduct and a bisphenol A propylene oxide adduct). Among these, as the polyhydric alcohol, for example, aromatic diols and alicyclic diols are preferable, and aromatic diols are more preferable.

As the polyhydric alcohol which is the polymerization component of the amorphous polyester resin, tri- or higher polyhydric alcohol having a crosslinked structure or a branched structure may be used together with the diol. Examples of the tri- or higher polyhydric alcohol include glycerin, trimethylolpropane, and pentaerythritol.

These polyhydric alcohols may be used alone, or two or more thereof may be used in combination.

A glass transition temperature (Tg) of the amorphous polyester resin may be 50° C. or higher and 80° C. or lower, and preferably 50° C. or higher and 65° C. or lower.

The glass transition temperature is obtained from a DSC curve obtained by differential scanning calorimetry (DSC). More specifically, the glass transition temperature is obtained from “extrapolated glass transition onset temperature” described in the method of obtaining a glass transition temperature in JIS K 7121-1987 “testing methods for transition temperatures of plastics”.

A weight average molecular weight (Mw) of the amorphous polyester resin may be 5,000 or more and 1,000,000 or less, and preferably 7,000 or more and 500,000 or less.

The number average molecular weight (Mn) of the amorphous polyester resin may be 2,000 or more and 100,000 or less.

The molecular weight distribution Mw/Mn of the amorphous polyester resin may be 1.5 or more and 100 or less, and more preferably 2 or more and 60 or less.

The weight average molecular weight and the number average molecular weight are measured by gel permeation chromatography (GPC). The molecular weight measurement by GPC is performed using GPCHLC-8120 GPC, manufactured by Tosoh Corporation as a measuring device, Column-TSK gel Super HM-M (15 cm), manufactured by Tosoh Corporation, and a THF solvent. The weight average molecular weight and the number average molecular weight are calculated by using a molecular weight calibration curve plotted from a monodisperse polystyrene standard sample from the results of the foregoing measurement.

A known preparing method is used to prepare the amorphous polyester resin. Specific examples thereof include a method of conducting a reaction at a polymerization temperature set to be 180° C. of higher and 230° C. or lower, if necessary, under reduced pressure in the reaction system, while removing water or an alcohol generated during condensation.

When monomers of the raw materials are not dissolved or compatibilized under a reaction temperature, a high-boiling-point solvent may be added as a solubilizing agent to dissolve the monomers. In this case, a polycondensation reaction is conducted while distilling away the solubilizing agent. When a monomer having poor compatibility is present in a copolymerization reaction, the monomer having poor compatibility and an acid or an alcohol to be polycondensed with the monomer may be previously condensed and then polycondensed with the major component.

—Crystalline Resin—

The crystalline resin may be a crystalline polyester resin.

Note that, as the crystalline polyester resin, a commercially available product may be used, or a synthetic product may be used.

Examples of the crystalline polyester resin include a polycondensate of polyvalent carboxylic acid and polyhydric alcohol. Since the crystalline polyester resin easily forms a crystal structure, a polycondensate using a linear aliphatic polymerizable monomer is more preferable than a polymerizable monomer having an aromatic ring.

Examples of the polyvalent carboxylic acid which is the polymerization component of the crystalline polyester resin include aliphatic dicarboxylic acids (for example, oxalic acid, succinic acid, glutaric acid, adipic acid, suberic acid, azelaic acid, sebacic acid, 1,9-nonanedicarboxylic acid, 1,10-decanedicarboxylic acid, 1,12-dodecandicarboxylic acid, 1,14-tetradecandicarboxylic acid, and 1,18-octadecanedicarboxylic acid), aromatic dicarboxylic acids (for example, dibasic acid such as phthalic acid, isophthalic acid, terephthalic acid, and naphthalene-2,6-dicarboxylic acid), anhydrides thereof, or lower (for example, 1 or more to 5 or less carbon atoms) alkyl esters thereof.

The polyvalent carboxylic acid may be used in combination with dicarboxylic acid and trivalent or higher carboxylic acid having a crosslinked structure or a branched structure. Examples of the trivalent carboxylic acid include aromatic carboxylic acids (for example, 1,2,3-benzenetricarboxylic acid, 1,2,4-benzenetricarboxylic acid, and 1,2,4-naphthalenetricarboxylic acid), anhydrides thereof, or lower (for example, 1 or more to 5 or less carbon atoms) alkyl esters thereof.

As the polyvalent carboxylic acid, a dicarboxylic acid having a sulfonic acid group and a dicarboxylic acid having an ethylenic double bond may be used in combination with these dicarboxylic acids.

These polyvalent carboxylic acids may be used alone, or two or more thereof may be used in combination.

The polyvalent carboxylic acid which is the polymerization component of the crystalline polyester resin may be a dicarboxylic acid from the viewpoint of controlling the value of the zeta potential of the crystalline polyester resin particle dispersion to −30 mV or more and −10 mV or less. Examples of the dicarboxylic acid include an aliphatic dicarboxylic acid. Examples of the aliphatic dicarboxylic acid include azelaic acid, sebacic acid, 1,9-nonanedicarboxylic acid, and 1,10-decanedicarboxylic acid.

A total amount of the aliphatic dicarboxylic acids may be 80 mol % or more and 95 mol % or less with respect to the total amount of the polyvalent carboxylic acid.

Examples of the polyhydric alcohol which is the polymerization component of the crystalline polyester resin include an aliphatic diol (for example, a linear aliphatic diol having 7 or more to 20 or less carbon atoms in a main chain portion). Examples of the aliphatic diol include ethylene glycol, 1,3-propanediol, 1,4-butanediol, 1,5-pentanediol, 1,6-hexanediol, 1,7-heptanediol, and 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among these, as the aliphatic diol, the 1,8-octanediol, the 1,9-nonanediol, and the 1,10-decanediol are preferable.

As the polyhydric alcohol which is the polymerization component of the crystalline polyester resin, trihydric or higher alcohol having a crosslinked structure or a branched structure may be used together with the diol. Examples of the trihydric or higher alcohol include glycerin, trimethylolethane, trimethylolpropane, and pentaerythritol.

These polyhydric alcohols may be used alone, or two or more thereof may be used in combination.

The content of the aliphatic diol in the polyhydric alcohol may be 80 mol % or more, preferably 90 mol % or more.

The polyhydric alcohol which is the polymerization component of the crystalline polyester resin may be a diol from the viewpoint of controlling the value of the zeta potential of the crystalline polyester resin particle dispersion to −30 mV or more and −10 mV or less. Examples of the diol include an aliphatic diol. Examples of the aliphatic diol include 1,6-hexanediol, 1,7-heptanediol, 1,8-octanediol, 1,9-nonanediol, 1,10-decanediol, 1,11-undecanediol, 1,12-dodecanediol, and 1,14-tetradecanediol.

A total amount of the aliphatic diols may be 80 mol % or more and 95 mol % or less with respect to the total amount of the polyhydric alcohols.

The melting temperature of the crystalline polyester resin may be 50° C. or higher and 100° C. or lower, preferably 55° C. or higher and 90° C. or lower, and more preferably 60° C. or higher and 85° C. or lower.

The melting temperature is obtained from a DSC curve obtained by differential scanning calorimetry (DSC), and specifically obtained from “melting peak temperature” described in the method of obtaining a melting temperature in JIS K 7121: 1987 “testing methods for transition temperatures of plastics”.

A weight average molecular weight (Mw) of the crystalline polyester resin may be 6,000 or more and 35,000 or less.

The crystalline polyester resin may be obtained by a known preparing method, similar to the amorphous polyester resin, for example.

—Other Binder Resins—

As the binder resin, a resin other than the polyester resin may be used in combination. Examples of other resins include a styrene acrylic resin, an epoxy resin, a polyurethane resin, a polyamide resin, a cellulose resin, and a polyether resin. These resins may be used alone, or two or more thereof may be used in combination.

—Release Agent—

Examples of the release agent include hydrocarbon waxes; natural waxes such as carnauba wax, rice wax, and candelilla wax; synthetic or mineral/petroleum waxes such as montan wax; and ester waxes such as fatty acid esters and montanic acid esters. The release agent is not limited to the examples.

The melting temperature of the release agent may be 50° C. or higher and 110° C. or lower, and preferably 60° C. or higher and 100° C. or lower.

The melting temperature of the release agent is obtained from a DSC curve obtained by differential scanning calorimetry (DSC), and specifically obtained in accordance with “melting peak temperature” described in the method of obtaining a melting temperature in JIS K 7121: 1987 “testing methods for transition temperatures of plastics”.

—Coloring Agent—

Examples of the coloring agent includes various types of pigments such as carbon black, chrome yellow, Hansa yellow, benzidine yellow, threne yellow, quinoline yellow, pigment yellow, Permanent Orange GTR, Pyrazolone Orange, Vulcan Orange, Watch Young Red, Permanent Red, Brilliant Carmine 3B, Brilliant Carmine 6B, DuPont Oil Red, Pyrazolone Red, Lithol Red, Rhodamine B Lake, Lake Red C, Pigment Red, Rose Bengal, Aniline Blue, Ultramarine Blue, Calco Oil Blue, Methylene Blue Chloride, Phthalocyanine Blue, Pigment Blue, Phthalocyanine Green, and Malachite Green Oxalate, or various types of dyes such as acridine dye, xanthene dye, azo dye, benzoquinone dye, azine dye, anthraquinone dye, thioindigo dye, dioxazine dye, thiazine dye, azomethine dye, indigo dye, phthalocyanine dye, aniline black dye, polymethine dye, triphenylmethane dye, diphenylmethane dye, and thiazole dye. These coloring agents may be used alone, or two or more thereof may be used in combination.

As the coloring agent, if necessary, a surface-treated coloring agent may be used, or a dispersant may be used in combination.

A weight ratio of the particles contained in the mixed dispersion may be in the following range from the viewpoint of preventing the gloss unevenness in an image from being generated.

The weight ratio between the amorphous resin particles and the crystalline resin particles may be amorphous resin particles:crystalline resin particles=97:3 to 70:30, preferably 95:5 to 75:25, and more preferably 92:8 to 80:20.

In a case where the mixed dispersion contains the release agent particles, the weight ratio may be (amorphous resin particles+crystalline resin particles):release agent particles=97:3 to 85:15, preferably 95:5 to 88:12, and more preferably 93:7 to 90:10.

When the mixed dispersion contains the coloring agent particles, (amorphous resin particles+crystalline resin particles): coloring agent particles=97:3 to 85:15 is preferable, 96:4 to 88:12 is more preferable, and 95:5 to 90:10 is further preferable.

The mixing step may include adjusting the pH of the mixed dispersion to 4.5 or more and 6.0 or less. When the mixed dispersion having a pH of 4.5 or more and 6.0 or less is subjected to the aggregating step, the material particles having a value of the zeta potential of the particle dispersion in the range are likely to aggregate without exception.

Examples of a method of adjusting the pH of the mixed dispersion include adding an acidic aqueous solution of nitric acid, hydrochloric acid, or sulfuric acid.

[Aggregating Step (First Aggregating Step)]

The aggregating step is a step of aggregating at least the amorphous resin particles and the crystalline resin particles to form the aggregated particles. In the aggregating step, the release agent particles may also be further aggregated, and the coloring agent particles may also be further aggregated.

In a case where the preparing method of a toner according to the exemplary embodiment includes a second aggregating step (step of forming a shell layer) to be described later, the above aggregating step is referred to as a “first aggregating step”. The first aggregating step is a step of forming a core in a toner having a core-shell structure.

The aggregating step includes adding an aggregating agent to the mixed dispersion while stirring the mixed dispersion, and heating the mixed dispersion while stirring the mixed dispersion after adding the aggregating agent to the mixed dispersion to raise the temperature of the mixed dispersion.

Examples of the aggregating agent include a surfactant having an opposite polarity to the polarity of the surfactant contained in the mixed dispersion, an inorganic metal salt, a divalent or more metal complex. These aggregating agents may be used alone, or two or more thereof may be used in combination.

Examples of the inorganic metal salt include: metal salt such as calcium chloride, calcium nitrate, barium chloride, magnesium chloride, zinc chloride, aluminum chloride, and aluminum sulfate; an inorganic metal salt polymer such as poly aluminum chloride, poly aluminum hydroxide, and calcium polysulfide; and the like.

The aggregating agent may be a divalent or higher valent metal salt compound, a trivalent metal salt compound is preferable, and a trivalent inorganic aluminum salt compound is more preferable. Examples of the trivalent inorganic aluminum salt compound include aluminum chloride, aluminum sulfate, polyaluminum chloride, and polyaluminum hydroxide.

The additive amount of the aggregating agent is not limited. In a case where the trivalent metal salt compound is used as the aggregating agent, the additive amount of the trivalent metal salt compound may be 0.3 parts by weight or more and 2 parts by weight or less, preferably 0.5 parts by weight or more and 1.5 parts by weight or less, and more preferably 0.6 parts by weight or more and 1.3 parts by weight or less, with respect to 100 parts by weight of the binder resin.

A temperature of the mixed dispersion reached when heating the mixed dispersion may be a temperature based on the glass transition temperature (Tg) of the amorphous resin particles, for example, (Tg −30° C.) or higher of the amorphous resin particles and (Tg−10° C.) or lower.

In a case where the mixed dispersion contains plural kinds of amorphous resin particles having different Tg, the lowest temperature of each Tg is used as the glass transition temperature in the aggregating step.

In the aggregating step, when the aggregating agent is added to the mixed dispersion and then the mixed dispersion is heated while stirring the mixed dispersion, it is favorable that the temperature of the mixed dispersion is relatively slowly raised at a heating rate of 0.2° C./min or less. By raising the temperature of the mixed dispersion relatively slowly, the various material particles are not aggregated at the same time, and the particles are likely to be aggregated in order from particles having a large absolute value of the zeta potential to particles having a small absolute value of the zeta potential. Therefore, by raising the temperature of the mixed dispersion relatively slowly, the amorphous resin particles are aggregated before the crystalline resin particles, and the crystalline resin particles are aggregated after the amorphous resin particles, and the crystalline resin particles are likely to be disposed near the surface of the aggregated particles.

The rate of raising the temperature of the mixed dispersion after adding the aggregating agent to the mixed dispersion may be 0.1° C./min or more and 0.2° C./min or less.

[Second Aggregating Step]

The second aggregating step is a step provided for the purpose of preparing a toner having a core-shell structure, and is a step provided after the first aggregating step. The second aggregating step is a step of forming a shell layer.

The second aggregating step is a step of further mixing a dispersion containing the aggregated particles and a dispersion containing resin particles to be a shell layer and aggregating the resin particles to be a shell layer on surfaces of the aggregated particles to form second aggregated particles.

The dispersion containing the resin particles to be the shell layer may be the amorphous resin particle dispersion for forming the core, and the amorphous polyester resin particle dispersion is preferable. The dispersion containing the resin particles to be the shell layer may not be used the crystalline resin particle dispersion from the viewpoint of preventing the crystalline resin from being exposed on the surface of the toner particles.

The second aggregating step includes adding a dispersion containing the amorphous resin particles to be the shell layer to a dispersion containing the aggregated particles while stirring the dispersion containing the aggregated particles, and heating the dispersion containing the aggregated particles after adding the dispersion containing the amorphous resin particles to be the shell layer while stirring the dispersion.

A temperature of the dispersion containing the aggregated particles reached when heating the dispersion containing the aggregated particles may be a temperature based on the glass transition temperature (Tg) of the amorphous resin particles to be the shell layer, for example, (Tg −30° C.) or higher of the amorphous resin particles to be the shell layer and (Tg−10° C.) or lower.

After the aggregated particles or the second aggregated particles are grown to a predetermined size and before heating of the coalescing step, a chelating agent relative to the aggregating agent used in the aggregating step may be added to the dispersion containing the aggregated particles and the second aggregated particles, for the purpose of stopping the growth of the aggregated particles and the second aggregated particles.

Examples of the chelating agent include: oxycarboxylic acid such as tartaric acid, citric acid, and gluconic acid; aminocarboxylic acid such as iminodiacetic acid (IDA), nitrilotriacetic acid (NTA), and ethylenediaminetetraacetic acid (EDTA); and the like.

The additive amount of the chelating agent may be, for example, 0.01 parts by weight or more and 5.0 parts by weight or less, and preferably 0.1 parts by weight or more and less than 3.0 parts by weight, with respect to 100 parts by weight of the binder resin particles.

After the aggregated particles or the second aggregated particles are grown to a predetermined size and before heating of the coalescing step, the pH of the dispersion containing the aggregated particles and the second aggregated particles may be raised, for the purpose of stopping the growth of the aggregated particles and the second aggregated particles.

Examples of a method of raising the pH of the dispersion containing the aggregated particles or the second aggregated particles include adding at least one selected from the group consisting of an aqueous solution of alkali metal hydroxide and aqueous solution of alkaline earth metal hydroxide.

A reached pH of the dispersion containing the aggregated particles or the second aggregated particles may be 8 or more and 10 or less.

[Coalescing Step]

The coalescing step is a step of coalescing the aggregated particles by heating a dispersion containing the aggregated particles to form toner particles.

In a case where the second aggregating step is provided before the coalescing step, the coalescing step is a step of coalescing the second aggregated particles by heating the dispersion containing the second aggregated particles to form toner particles. The toner particles having a core-shell structure may be prepared by going through the second aggregating step and the coalescing step.

The exemplary embodiment to be described below is common to the aggregated particles and the second aggregated particles.

The reached temperature of the dispersion containing the aggregated particles may be glass transition temperature (Tg) of the amorphous resin particles or higher, and specifically, a temperature 10° C. to 30° C. higher than the Tg of the amorphous resin particles is preferable.

In a case where the aggregated particles contain plural kinds of amorphous resin particles having different Tg, the highest temperature of each Tg is used as the glass transition temperature in the coalescing step.

After completion of the coalescing step, a dried toner particles are obtained by subjecting the toner particles in the dispersion to known cleaning step, a solid-liquid separation step, and drying step. In the cleaning step, displacement cleaning using ion exchanged water may be sufficiently performed from the viewpoint of charging properties. For the solid-liquid separation step, suction filtration, pressure filtration, or the like may be performed from the viewpoint of productivity. For the drying step, freeze drying, airflow drying, fluidized drying, vibration-type fluidized drying, or the like may be performed from the viewpoint of productivity.

[Step of Externally Adding External Additive]

The preparing method of a toner according to the exemplary embodiment favorably includes a step of externally adding an external additive to the toner particles.

The external addition of the external additive to the toner particles is performed by mixing the dry toner particles and the external additive. The mixing may be performed with, for example, a V-blender, a Henschel mixer, a Lodige mixer, or the like. Furthermore, if necessary, coarse particles of the toner may be removed by using a vibration classifier, a wind classifier, or the like.

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, MgSO₄, and the like.

The surface of the inorganic particles as the external additive may be treated with a hydrophobizing agent. The hydrophobic treatment is performed, for example, by immersing the inorganic particles in a hydrophobizing agent. The hydrophobizing agent is not particularly limited, and examples thereof include a silane coupling agent, a silicone oil, a titanate coupling agent, and an aluminum coupling agent. These may be used alone, or two or more thereof may be used in combination.

The amount of the hydrophobizing agent is usually, for example, 1 part by weight or more and 10 parts by weight or less with respect to 100 parts by weight of the inorganic particles.

Examples of the external additive also include a resin particle (resin particles such as polystyrene, polymethylmethacrylate, and melamine resin), a cleaning aid (for example, a metal salt of higher fatty acid typified by zinc stearate, and a particle of fluorine-based high molecular weight body), and the like.

The external addition amount of the external additives may be 0.01% by weight or more and 5% by weight or less and preferably 0.01% by weight or more and 2.0% by weight or less, with respect to the weight of the toner particles.

<Toner>

The toner prepared by the preparing method according to the exemplary embodiment may be an external additive toner in which an external additive is externally added to the toner particles. The form of the external additive is as described above.

The toner prepared by the preparing method according to the exemplary embodiment may be a toner having a single-layer structure, or may be a toner having a core-shell structure including a core portion (core) and a coating layer (shell layer) coating the core portion. The toner having the core-shell structure has: for example, a core portion containing an amorphous resin, a crystalline resin, and a release agent; and a coating layer containing an amorphous resin. In the toner having the core-shell structure, the core portion may contain a coloring agent.

The amorphous resin contained in the toner may be an amorphous polyester resin.

The crystalline resin contained in the toner may be a crystalline polyester resin.

The content of the crystalline polyester resin in the toner may be 3% by weight or more and 30% by weight or less, and preferably 8% by weight or more and 20% by weight or less of the entire binder resin.

The content of the binder resin may be 40% by weight or more and 95% by weight or less, preferably 50% by weight or more and 90% by weight or less, and more preferably 60% by weight or more and 85% by weight or less, with respect to the entire toner particles.

The content of the release agent may be from 1% by weight or more to 20% by weight or less, and preferably from 5% by weight or more to 15% by weight or less with respect to the entire toner.

When the toner contains the coloring agent, the content of the coloring agent may be 1% by weight or more and 30% by weight or less, and preferably 3% by weight or more and 15% by weight or less, with respect to the entire toner.

The volume average particle diameter of the toner particles may be 2 μm or more and 10 μm or less and preferably 4 μm or more and 8 μm or less. A measuring method of the volume average particle diameter of the toner is as follows.

The particle size distribution of the toner is measured using Coulter Multisizer Type II (manufactured by Beckman Coulter, Inc.) and using ISOTON-II (manufactured by Beckman Coulter, Inc.) as the electrolytic solution. In the measurement, a measurement sample of 0.5 mg or more and 50 mg or less is added to 2 ml of 5% by weight aqueous solution of a surfactant (preferably sodium alkylbenzene sulfonate) as a dispersant. This is added to the electrolytic solution of 100 ml or more to 150 ml or less. The electrolytic solution in which the sample is suspended is dispersed for 1 minute by an ultrasonic dispersion. Then, using the Coulter Multisizer II type, the particle size distribution of the particles having a particle diameter of from 2 μm or more to 60 μm or less is measured using an aperture having an aperture diameter of 100 μm. The number of particles to be sampled is 50,000. The particle size distribution is drawn from the small diameter side, and a particle diameter at a cumulative total of 50% is defined as the volume average particle diameter D50v.

The average circularity of the toner may be 0.94 or more and 1.00 or less, and preferably 0.95 or more and 0.98 or less.

The average circularity of the toner is (Perimeter of a circle with the same area as a particle projection image)/(Perimeter of the particle projection image). The average circularity of the toner is determined by sampling 3,500 particles with a flow-type particle image analyzer (FPIA-3000 manufactured by SYSMEX CORPORATION).

<Developer>

The toner prepared by the preparing method according to the exemplary embodiment may be used as a single-component developer, or may be used as a two-component developer by mixing with a carrier.

The carrier is not particularly limited, and a well-known carrier may be used. Examples of the carrier include a coating carrier in which the surface of the core formed of magnetic particles is coated with the resin; a magnetic particle dispersion-type carrier in which the magnetic particles are dispersed and distributed in the matrix resin; and a resin impregnated-type carrier in which a resin is impregnated into the porous magnetic particles.

The magnetic particle dispersion-type carrier or the resin impregnated-type carrier may be a carrier in which the forming particle of the carrier is set as a core and the surface of the core is coated with the resin.

Examples of the magnetic particle include: a magnetic metal such as iron, nickel, and cobalt; a magnetic oxide such as ferrite, and magnetite; and the like.

Examples of the coating resin and the matrix resin include a straight silicone resin formed by containing polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid ester copolymer, and an organosiloxane bond, or the modified products thereof, a fluororesin, polyester, polycarbonate, a phenol resin, and an epoxy resin. Other additives such as the conductive particles may be contained in the coating resin and the matrix resin. Examples of the conductive particles include metal such as gold, silver, and copper, carbon black, titanium oxide, zinc oxide, tin oxide, barium sulfate, aluminum borate, and potassium titanate.

Here, in order to coat the surface of the core with the resin, a method of coating the surface with a coating layer forming solution in which the coating resin and various additives (to be used if necessary) are dissolved in a proper solvent is used. The solvent is not particularly limited as long as a solvent is selected in consideration of a kind of a resin to be used and coating suitability.

Specific examples of the resin coating method include: a dipping method of dipping the core into the coating layer forming solution; a spray method of spraying the coating layer forming solution onto the surface of the core; a fluid-bed method of spraying the coating layer forming solution to the core in a state of being floated by the fluid air; a kneader coating method of mixing the core of the carrier with the coating layer forming solution and removing a solvent in the kneader coater; and the like.

The mixing ratio (weight ratio) of the toner to the carrier in the two-component developer may be in a range of toner:carrier=1:100 to 30:100, and preferably in a range of 3:100 to 20:100.

### EXAMPLES

Hereinafter, exemplary embodiments of the disclosure will be described in detail with reference to examples, but the exemplary embodiments of the disclosure are not limited to these examples.

In the following description, unless otherwise specified, “part(s)” and “%” are based on weight.

Unless otherwise specified, synthesis, treatment, preparation and the like are carried out at a room temperature (25° C.±3° C.).

<Preparation of Particle Dispersion>

[Preparation of Amorphous Polyester Resin Particle Dispersion (A1)]
Terephthalic acid: 30 mol parts
Fumaric acid: 70 mol parts
Bisphenol A ethylene oxide adduct: 5 mol parts
Bisphenol A propylene oxide adduct: 95 mol parts

The above materials are placed in a flask equipped with a stirrer, a nitrogen introduction tube, a temperature sensor, and a rectification tower, the temperature is raised to 220° C. over 1 hour, and 1 part of titanium tetraethoxydo is added to 100 parts of the materials. The temperature is raised to 230° C. over 30 minutes while distilling off the water produced, the dehydration condensation reaction is continued at the temperature for 1 hour, and then a reaction product is cooled to obtain an amorphous polyester resin (A1) (weight average molecular weight 18,000, glass transition temperature 59° C.).

40 parts of ethyl acetate and 25 parts of 2-butanol are added to a vessel provided with a temperature controller and a nitrogen substitution unit to prepare a mixed solvent, and then 100 parts of the amorphous polyester resin (A1) is slowly added and dissolved, and 10% aqueous ammonia solution (equivalent to 3 times the molar ratio of the acid value of the resin) is added thereto, and the mixture is stirred for 30 minutes. Next, an inside of the vessel is replaced with dry nitrogen, the temperature is kept at 40° C., and 400 parts of ion exchanged water is added dropwise while stirring the mixture to emulsify. After completion of the dropping, the emulsion is returned to 25° C. to obtain a dispersion in which resin particles having a volume average particle diameter of 180 nm are dispersed. Ion exchanged water is added to the dispersion to adjust the solid content to 20% to obtain an amorphous polyester resin particle dispersion (A1).

A value of a zeta potential of the amorphous polyester resin particle dispersion (A1) is measured and found to be −47 mV.

[Preparation of Amorphous Polyester Resin Particle Dispersion (A2)]
Terephthalic acid: 35 mol parts
Fumaric acid: 70 mol parts
Bisphenol A ethylene oxide adduct: 5 mol parts
Bisphenol A propylene oxide adduct: 95 mol parts

The above materials are placed in a flask equipped with a stirrer, a nitrogen introduction tube, a temperature sensor, and a rectification tower, the temperature is raised to 220° C. over 1 hour, and 1 part of titanium tetraethoxydo is added to 100 parts of the materials. The temperature is raised to 230° C. over 30 minutes while distilling off the water produced, the dehydration condensation reaction is continued at the temperature for 1 hour, and then a reaction product is cooled to obtain an amorphous polyester resin (A2) (weight average molecular weight 17,000, glass transition temperature 60° C.).

40 parts of ethyl acetate and 25 parts of 2-butanol are added to a vessel provided with a temperature controller and a nitrogen substitution unit to prepare a mixed solvent, and then 100 parts of the amorphous polyester resin (A2) is slowly added and dissolved, and 10% aqueous ammonia solution (equivalent to 3 times the molar ratio of the acid value of the resin) is added thereto, and the mixture is stirred for 30 minutes. Next, an inside of the vessel is replaced with dry nitrogen, the temperature is kept at 40° C., and 400 parts of ion exchanged water is added dropwise while stirring the mixture to emulsify. After completion of the dropping, the emulsion is returned to 25° C. to obtain a dispersion in which resin particles having a volume average particle diameter of 170 nm are dispersed. Ion exchanged water is added to the dispersion to adjust the solid content to 20% to obtain an amorphous polyester resin particle dispersion (A2).

A value of a zeta potential of the amorphous polyester resin particle dispersion (A2) is measured and found to be −64 mV.

[Preparation of Crystalline Polyester Resin Particle Dispersion (C1)]
Sebacic acid: 233 parts by weight
1,10-decanediol: 248 parts by weight

The above materials are charged into a flask, the temperature is raised to 160° C. for 1 hour, and after checking that the inside of a reaction system is uniformly stirred, 0.03 parts of dibutyltin oxide is charged. The temperature is raised to 200° C. over 6 hours while distilling off the water produced, and the stirring is continued at 200° C. over 4 hours. Next, the reaction solution is cooled, solid-liquid separation is performed, and the solid is dried at a temperature of 40° C./under reduced pressure to obtain a crystalline polyester resin (C1) (weight average molecular weight: 11,500, melting temperature: 71° C.).

50 parts of crystalline polyester resin (C1), 2 parts of anionic surfactant (Daiichi Kogyo Seiyaku Co., Ltd., Neogen RK), and 200 parts of ion exchanged water are mixed, heated to 120° C., and sufficiently dispersed with a homogenizer (Ultra Tarax T50, IKA), and then subjected to a dispersion treatment with a pressure discharge homogenizer. When the volume average particle diameter becomes 180 nm, the particles are collected to obtain a crystalline polyester resin particle dispersion (C1) having a solid content of 20%.

A value of a zeta potential of the crystalline polyester resin particle dispersion (C1) is measured and found to be −19 mV.

[Preparation of Crystalline Polyester Resin Particle Dispersion (C2)]
Sebacic acid: 256 parts by weight
1,10-decanediol: 248 parts by weight

The above materials are charged into a flask, the temperature is raised to 160° C. for 1 hour, and after checking that the inside of a reaction system is uniformly stirred, 0.03 parts of dibutyltin oxide is charged. The temperature is raised to 200° C. over 6 hours while distilling off the water produced, and the stirring is continued at 200° C. over 4 hours. Next, the reaction solution is cooled, solid-liquid separation is performed, and the solid is dried at a temperature of 40° C./under reduced pressure to obtain a crystalline polyester resin (C2) (weight average molecular weight: 11,000, melting temperature: 73° C.).

50 parts of crystalline polyester resin (C2), 2 parts of anionic surfactant (Daiichi Kogyo Seiyaku Co., Ltd., Neogen RK), and 200 parts of ion exchanged water are mixed, heated to 120° C., and sufficiently dispersed with a homogenizer (Ultra Tarax T50, IKA), and then subjected to a dispersion treatment with a pressure discharge homogenizer. When the volume average particle diameter becomes 170 nm, the particles are collected to obtain a crystalline polyester resin particle dispersion (C2) having a solid content of 20%.

A value of a zeta potential of the crystalline polyester resin particle dispersion (C2) is measured and found to be −28 mV.

[Preparation of Crystalline Polyester Resin Particle Dispersion (C3)]
1,9-Nonanedicarboxylic acid: 249 parts by weight
1,8-Octanediol: 208 parts by weight

The above materials are charged into a flask, the temperature is raised to 160° C. for 1 hour, and after checking that the inside of a reaction system is uniformly stirred, 0.03 parts of dibutyltin oxide is charged. The temperature is raised to 200° C. over 6 hours while distilling off the water produced, and the stirring is continued at 200° C. over 4 hours. Next, the reaction solution is cooled, solid-liquid separation is performed, and the solid is dried at a temperature of 40° C./under reduced pressure to obtain a crystalline polyester resin (C3) (weight average molecular weight: 11,000, melting temperature: 74° C.).

50 parts of crystalline polyester resin (C3), 2 parts of anionic surfactant (Daiichi Kogyo Seiyaku Co., Ltd., Neogen RK), and 200 parts of ion exchanged water are mixed, heated to 120° C., and sufficiently dispersed with a homogenizer (Ultra Tarax T50, IKA), and then subjected to a dispersion treatment with a pressure discharge homogenizer. When the volume average particle diameter becomes 180 nm, the particles are collected to obtain a crystalline polyester resin particle dispersion (C3) having a solid content of 20%.

The value of the zeta potential of the crystalline polyester resin particle dispersion (C3) is measured and found to be −39 mV.

[Preparation of Crystalline Polyester Resin Particle Dispersion (C4)]
1,10-Decanedicarboxylic acid: 265 parts by weight
1,6-Hexanediol: 168 parts by weight

The above materials are charged into a flask, the temperature is raised to 160° C. for 1 hour, and after checking that the inside of a reaction system is uniformly stirred, 0.03 parts of dibutyltin oxide is charged. The temperature is raised to 200° C. over 6 hours while distilling off the water produced, and the stirring is continued at 200° C. over 4 hours. Next, the reaction solution is cooled, solid-liquid separation is performed, and the solid is dried at a temperature of 40° C./under reduced pressure to obtain a crystalline polyester resin (C4) (weight average molecular weight: 12,000, melting temperature: 75° C.).

50 parts of crystalline polyester resin (C4), 2 parts of anionic surfactant (Daiichi Kogyo Seiyaku Co., Ltd., Neogen RK), and 200 parts of ion exchanged water are mixed, heated to 120° C., and sufficiently dispersed with a homogenizer (Ultra Tarax T50, IKA), and then subjected to a dispersion treatment with a pressure discharge homogenizer. When the volume average particle diameter becomes 180 nm, the particles are collected to obtain a crystalline polyester resin particle dispersion (C4) having a solid content of 20%.

The value of the zeta potential of the crystalline polyester resin particle dispersion (C4) is measured and found to be −50 mV.

[Preparation of Release Agent Particle Dispersion (W)]
Paraffin wax (Nippon Seiro Co., Ltd., HNP-9, melting temperature: 75° C.): 100 parts
Anionic surfactant (NEOGEN RK, Dai-Ichi Kogyo Seiyaku Co., Ltd.): 1 part
Ion exchanged water: 350 parts

The materials are mixed, heated to 100° C., and dispersed using a homogenizer (Ultratarax T50 manufactured by IKA). Next, the mixture is dispersed with a pressure discharge type gaulin homogenizer, and water is added to adjust the solid content to 20% to obtain a release agent particle dispersion (W). The volume average particle diameter of the release agent particle dispersion (W) is 200 nm.

[Preparation of Coloring Agent Particle Dispersion (C)]
Cyan pigment (Pigment Blue 15:3, Dainichiseika Kogyo): 50 parts
Anionic surfactant (NEOGEN RK, Dai-Ichi Kogyo Seiyaku Co., Ltd.): 5 parts
Ion exchanged water: 195 parts

The above materials are mixed and dispersed for 60 minutes by using a high-pressure impact disperser (Ultimaizer HJP30006, manufactured by Sugino Machine Ltd.) to obtain a coloring agent particle dispersion (C) having a solid content of 20%.

### Example 1

[Mixing Step]
Ion exchanged water: 215 parts
Amorphous polyester resin particle dispersion (A1): 250 parts
Crystalline polyester resin particle dispersion (C3): 40 parts
Release agent particle dispersion (W): 40 parts
Coloring agent particle dispersion (C): 20 parts
Anionic surfactant (Daiichi Kogyo Seiyaku Co., Ltd., Neogen RK): 2.8 parts

The above materials are added in a reaction vessel provided with a thermometer, a pH meter, and a stirrer. While controlling the temperature from the outside of the reaction vessel to 30° C. with a mantle heater, the mixture is kept for 30 minutes while stirring at a stirring rotation speed of 150 rpm. Then, the pH of the mixed dispersion is adjusted to 5.5 with a 0.3N aqueous nitric acid solution.

[First Aggregating Step]

A PAC aqueous solution in which 0.7 parts of polyaluminum chloride (Oji Paper Co., Ltd., active ingredient: 30%, powder product) is dissolved in 7 parts of ion exchanged water is prepared. The PAC aqueous solution is added while dispersing the mixed dispersion with a homogenizer (Ultratarax T50 manufactured by IKA). Then, while stirring the mixed dispersion, a temperature is raised to 48° C. at a heating rate of 0.1° C./min. When the temperature of the dispersion reaches 48° C., the particle diameter of the aggregated particles is measured with a Coulter Multisizer II (aperture diameter: 50 μm), and the volume average particle diameter is 5.0 μm.

[Second Aggregating Step]

A pH of 150 parts of the amorphous polyester resin particle dispersion (A1) is adjusted to 4.0 with a 0.3 N aqueous nitric acid solution, and the mixture is added to the dispersion containing the aggregated particles while continuing stirring. Then, the temperature of the dispersion is raised to 50° C. while stirring. When the temperature of the dispersion reaches 50° C., the particle diameter of the second aggregated particles is measured with a Coulter Multisizer II (aperture diameter: 50 μm), and the volume average particle diameter is 5.8 μm.

20 parts of a 10% sodium nitrilotriacetate aqueous solution (Killest Co., Ltd., Killest 70) is added to the dispersion containing the second aggregated particles, and then the pH is adjusted to 9.0 with a 1 N aqueous solution of sodium hydroxide.

[Coalescing Step]

The dispersion containing the second aggregated particles is heated to 87° C. and kept for 60 minutes. Then, the dispersion is cooled to a room temperature and a solid content is filtered off. The solid content is redistributed in ion exchanged water, filtration is repeated, and cleaning is performed until the electrical conductivity of the filtrate becomes 20 μS/cm or less. Next, the toner particles are obtained by vacuum drying in a vacuum dryer having an internal temperature of 40° C. for 5 hours. The volume average particle diameter of the toner particles is 5.8 μm.

[Addition of External Additive]

100 parts of toner particles and 1.5 parts of hydrophobic silica particles (RY50, Nippon Aerosil Co., Ltd.) are added in a sample mill and mixed at a rotation speed of 10,000 rpm for 30 seconds. Then, the toner is obtained by sieving with a vibrating sieve having a mesh size of 45 μm.

[Preparation of Carrier]
Mn—Mg—Sr ferrite particles (average particle diameter: 40 μm): 100 parts
Toluene: 14 parts
Polymethyl methacrylate: 2 parts
Carbon black (Cabot, VXC72): 0.12 parts

Glass beads (diameter: 1 mm, the same amount as that of toluene) and the materials excluding the ferrite particles are mixed and stirred at a rotation speed of 1,200 rpm for 30 minutes using a sand mill manufactured by Kansai Paint Co., Ltd. to obtain a dispersion. The dispersion and the ferrite particles are added in a vacuum degassing type kneader, and the pressure is reduced while stirring to dry the mixture to obtain a carrier.

[Preparation of Developer]

10 parts of the toner and 100 parts of the carrier are added in a V-type blender and stirred for 20 minutes, and then sieved with a vibrating sieve having a mesh size of 212 μm to obtain a developer.

### Comparative Example 1

[Mixing Step]
Ion exchanged water: 215 parts
Amorphous polyester resin particle dispersion (A1): 250 parts
Crystalline polyester resin particle dispersion (C4): 40 parts
Release agent particle dispersion (W): 40 parts
Coloring agent particle dispersion (C): 20 parts
Anionic surfactant (Daiichi Kogyo Seiyaku Co., Ltd., Neogen RK): 2.8 parts

The above materials are added in a reaction vessel provided with a thermometer, a pH meter, and a stirrer. While controlling the temperature from the outside of the reaction vessel to 30° C. with a mantle heater, the mixture is kept for 30 minutes while stirring at a stirring rotation speed of 150 rpm. Then, the pH of the mixed dispersion is adjusted to 3.0 with a 0.3N aqueous nitric acid solution.

[First Aggregating Step]

A PAC aqueous solution in which 0.7 parts of polyaluminum chloride (Oji Paper Co., Ltd., active ingredient: 30%, powder product) is dissolved in 7 parts of ion exchanged water is prepared. The PAC aqueous solution is added while dispersing the mixed dispersion with a homogenizer (Ultratarax T50 manufactured by IKA Japan). Then, while stirring the mixed dispersion, a temperature is raised to 48° C. at a heating rate of 0.3° C./min. When the temperature of the dispersion reaches 48° C., the particle diameter of the aggregated particles is measured with a Coulter Multisizer II (aperture diameter: 50 μm), and the volume average particle diameter is 5.0 μm.

[Second Aggregating Step]

A pH of 150 parts of the amorphous polyester resin particle dispersion (A1) is adjusted to 4.0 with a 0.3 N aqueous nitric acid solution, and the mixture is added to the dispersion containing the aggregated particles while continuing stirring. Then, the temperature of the dispersion is raised to 50° C. while stirring. When the temperature of the dispersion reaches 50° C., the particle diameter of the second aggregated particles is measured with a Coulter Multisizer II (aperture diameter: 50 μm), and the volume average particle diameter is 5.8 μm.

20 parts of a 10% sodium nitrilotriacetate aqueous solution (Killest Co., Ltd., Killest 70) is added to the dispersion containing the second aggregated particles, and then the pH is adjusted to 9.0 with a 1 N aqueous solution of sodium hydroxide.

[Coalescing Step]

The dispersion containing the second aggregated particles is heated to 87° C. and kept for 60 minutes. Then, the dispersion is cooled to a room temperature and a solid content is filtered off. The solid content is redistributed in ion exchanged water, filtration is repeated, and cleaning is performed until the electrical conductivity of the filtrate becomes 20 μS/cm or less. Next, the toner particles are obtained by vacuum drying in a vacuum dryer having an internal temperature of 40° C. for 5 hours. The volume average particle diameter of the toner particles is 5.8 μm.

Then, as in Example 1, an external additive is added to the toner particles and mixed with a carrier to obtain a developer.

### Examples 2 to 19

Toner particles are obtained in the same manner as in Example 1 except that kinds of the amorphous polyester resin, kinds of the crystalline polyester resin, the amount of the dispersion to be mixed in the mixing step, the pH to be adjusted in the mixing step, and a heating rate in the first aggregating step are changed to specifications shown in Table 1. Then, as in Example 1, an external additive is added to the toner particles and mixed with a carrier to obtain a developer.

<Performance Evaluation>

[Gloss Unevenness]

Using the developers obtained in Examples and Comparative Examples, gloss unevenness is evaluated as follows.

A developing machine of an image forming apparatus “DocuCenter color 400 manufactured by Fuji Xerox Co., Ltd.” is filled with a developer. Plain paper (manufactured by Canon Inc., trade name: CS-520, A3 size) stored at a temperature of 28° C. and a relative humidity of 85% for 10 hours is prepared.

With the image forming apparatus, 50 sheets of the plain paper are output in a blank state at a process speed of 308 mm/s and a fixing temperature of 150° C. in an environment of a temperature of 28° C. and a relative humidity of 85%. Next, 100 solid images (images with a toner applied amount of 10.0 g/m²) having a length of 50 mm and a width of 280 mm on a leading edge of the plain paper are output. Gloss is measured on the 1st, 10th, and 100th solid images. For gloss measurement, a portable gloss meter (BYK Gardner Micro Trigloss, manufactured by Toyo Seiki Seisakusho Co., Ltd.) is used to measure 60-degree gloss at five locations of the center, upper right edge, lower right edge, upper left edge, the lower left edge of the solid image. A standard deviation is calculated from the measured values of gloss and classified as follows.

A: The standard deviation of 15 points at the measurement points of the 1st, 10th and 100th sheets is less than 1.5.

B: The standard deviation of 15 points at the measurement points of the 1st, 10th and 100th sheets is less than 2.

C: The standard deviation of 15 points at the measurement points of the 1st, 10th and 100th sheets is less than 3.

D: The standard deviation of 15 points at the measurement points of the 1st, 10th and 100th sheets is less than 5.

E: The standard deviation of 15 points at the measurement points of the 1st, 10th and 100th sheets is less than 7.

F: The standard deviation of 15 points at the measurement points of the 1st, 10th and 100th sheets is 7 or more.

TABLE 1

| | | | | | | Mixing step | | | | | |
|---|---|---|---|---|---|---|---|---|---|---|---|
| | | | | | | Amorphous | Crystalline | | | Heating | |
| | | | Value of zeta potential | | | resin | resin | Weight | | rate of | |
| | | | Amorphous | Crystalline | | particle | particle | ratio of | | first | |
| | Polyester resin | | resin particle | resin particle | | dispersion | dispersion | resin | pH | aggregating | Gloss |
| | Amorphous | Crystalline | dispersion | dispersion | D1 | Part(s) by | Part(s) by | particles | adjustment | step | unevenness |
| | Kind | Kind | mV | mV | mV | weight | weight | — | — | ° C./min | — |
| Comparative | A1 | C4 | −47 | −50 | −3 | 250 | 40 | 86:14 | 3.0 | 0.3 | F |
| Example 1 | | | | | | | | | | | |
| Example 1 | A1 | C3 | −47 | −39 | 8 | 250 | 40 | 86:14 | 5.5 | 0.1 | D |
| Example 2 | A1 | C3 | −47 | −39 | 8 | 250 | 40 | 86:14 | 3.0 | 0.3 | E |
| Example 3 | A1 | C2 | −47 | −28 | 19 | 250 | 40 | 86:14 | 5.5 | 0.1 | A |
| Example 4 | A1 | C1 | −47 | −19 | 28 | 250 | 40 | 86:14 | 5.5 | 0.1 | A |
| Example 5 | A2 | C4 | −64 | −50 | 14 | 250 | 40 | 86:14 | 5.5 | 0.1 | D |
| Example 6 | A2 | C3 | −64 | −39 | 25 | 250 | 40 | 86:14 | 5.5 | 0.1 | C |
| Example 7 | A2 | C2 | −64 | −28 | 36 | 250 | 40 | 86:14 | 5.5 | 0.1 | B |
| Example 8 | A2 | C1 | −64 | −19 | 45 | 250 | 40 | 86:14 | 5.5 | 0.1 | B |
| Example 9 | A1 | C1 | −47 | −19 | 28 | 250 | 40 | 86:14 | 3.0 | 0.1 | C |
| Example 10 | A2 | C1 | −64 | −19 | 45 | 250 | 40 | 86:14 | 3.0 | 0.1 | D |
| Example 11 | A1 | C1 | −47 | −19 | 28 | 250 | 40 | 86:14 | 4.3 | 0.1 | C |
| Example 12 | A1 | C1 | −47 | −19 | 28 | 250 | 40 | 86:14 | 4.8 | 0.1 | B |
| Example 13 | A1 | C1 | −47 | −19 | 28 | 250 | 40 | 86:14 | 5.5 | 0.2 | B |
| Example 14 | A1 | C1 | −47 | −19 | 28 | 250 | 40 | 86:14 | 5.5 | 0.3 | D |
| Example 15 | A1 | C1 | −47 | −19 | 28 | 282.5 | 7.5 | 97.4:2.6 | 5.5 | 0.1 | E |
| Example 16 | A1 | C1 | −47 | −19 | 28 | 280 | 10 | 96.6:3.4 | 5.5 | 0.1 | D |
| Example 17 | A1 | C1 | −47 | −19 | 28 | 230 | 60 | 79:21 | 5.5 | 0.1 | A |
| Example 18 | A1 | C1 | −47 | −19 | 28 | 210 | 80 | 72:28 | 5.5 | 0.1 | C |
| Example 19 | A1 | C1 | −47 | −19 | 28 | 190 | 100 | 66:34 | 5.5 | 0.1 | D |

What is claimed is:

1. A preparing method of an electrostatic charge image developing toner, the method comprising:
mixing an amorphous resin particle dispersion containing amorphous resin particles and a crystalline resin particle dispersion containing crystalline resin particles to prepare a mixed dispersion containing the amorphous resin particles and the crystalline resin particles;
aggregating the amorphous resin particles and the crystalline resin particles in the mixed dispersion to form aggregated particles; and
coalescing the aggregated particles by heating a dispersion containing the aggregated particles to form toner particles,
wherein both a zeta potential of the amorphous resin particle dispersion and a zeta potential of the crystalline resin particle dispersion are negative values, and
an absolute value of the zeta potential of the crystalline resin particle dispersion is smaller than an absolute value of the zeta potential of the amorphous resin particle dispersion.

2. The preparing method of an electrostatic charge image developing toner according to claim 1,
wherein a difference D1 between a value of the zeta potential of the amorphous resin particle dispersion and a value of the zeta potential of the crystalline resin particle dispersion is 10 mV or more and 50 mV or less.

3. The preparing method of an electrostatic charge image developing toner according to claim 1,
wherein a value of the zeta potential of the amorphous resin particle dispersion is −70 mV or more and −30 mV or less, and
a value of the zeta potential of the crystalline resin particle dispersion is −30 mV or more and −10 mV or less.

4. The preparing method of an electrostatic charge image developing toner according to claim 2,
wherein a value of the zeta potential of the amorphous resin particle dispersion is −70 mV or more and −30 mV or less, and
a value of the zeta potential of the crystalline resin particle dispersion is −30 mV or more and −10 mV or less.

5. The preparing method of an electrostatic charge image developing toner according to claim 1,
wherein the mixing includes adjusting a pH of the mixed dispersion to 4.5 or more and 6.0 or less.

6. The preparing method of an electrostatic charge image developing toner according to claim 2,
wherein the mixing includes adjusting a pH of the mixed dispersion to 4.5 or more and 6.0 or less.

7. The preparing method of an electrostatic charge image developing toner according to claim 3,
wherein the mixing includes adjusting a pH of the mixed dispersion to 4.5 or more and 6.0 or less.

8. The preparing method of an electrostatic charge image developing toner according to claim 4,
wherein the mixing includes adjusting a pH of the mixed dispersion to 4.5 or more and 6.0 or less.

9. The preparing method of an electrostatic charge image developing toner according to claim 1,
wherein the aggregating includes
adding an aggregating agent to the mixed dispersion, and
increasing a temperature of the mixed dispersion after adding the aggregating agent to the mixed dispersion at a heating rate of 0.2° C./min or less.

10. The preparing method of an electrostatic charge image developing toner according to claim 2,
wherein the aggregating includes
adding an aggregating agent to the mixed dispersion, and
increasing a temperature of the mixed dispersion after adding the aggregating agent to the mixed dispersion at a heating rate of 0.2° C./min or less.

11. The preparing method of an electrostatic charge image developing toner according to claim 3,
wherein the aggregating includes
adding an aggregating agent to the mixed dispersion, and
increasing a temperature of the mixed dispersion after adding the aggregating agent to the mixed dispersion at a heating rate of 0.2° C./min or less.

12. The preparing method of an electrostatic charge image developing toner according to claim 4,
wherein the aggregating includes
adding an aggregating agent to the mixed dispersion, and
increasing a temperature of the mixed dispersion after adding the aggregating agent to the mixed dispersion at a heating rate of 0.2° C./min or less.

13. The preparing method of an electrostatic charge image developing toner according to claim 5,
wherein the aggregating includes
adding an aggregating agent to the mixed dispersion, and
increasing a temperature of the mixed dispersion after adding the aggregating agent to the mixed dispersion at a heating rate of 0.2° C./min or less.

14. The preparing method of an electrostatic charge image developing toner according to claim 6,
wherein the aggregating includes
adding an aggregating agent to the mixed dispersion, and
increasing a temperature of the mixed dispersion after adding the aggregating agent to the mixed dispersion at a heating rate of 0.2° C./min or less.

15. The preparing method of an electrostatic charge image developing toner according to claim 1,
wherein the amorphous resin particles include amorphous polyester resin particles, and the crystalline resin particles include crystalline polyester resin particles.

16. The preparing method of an electrostatic charge image developing toner according to claim 1,
wherein in the mixing, a weight ratio between the amorphous resin particles and the crystalline resin particles contained in the mixed dispersion is amorphous resin particles:crystalline resin particles=97:3 to 70:30.

17. The preparing method of an electrostatic charge image developing toner according to claim 1,
wherein in the mixing, at least one of a release agent particle dispersion containing release agent particles or a coloring agent particle dispersion containing coloring agent particles is further mixed, and the mixed dispersion further containing at least one of the release agent particles or the coloring agent particles is prepared, and
in the aggregating, at least one of the release agent particles or the coloring agent particles is further aggregated to form the aggregated particles.

18. The preparing method of an electrostatic charge image developing toner according to claim 1, further comprising:
after the aggregating, second aggregating of further mixing a dispersion containing the aggregated particles and a dispersion containing resin particles to be a shell layer and aggregating the resin particles to be the shell layer on surfaces of the aggregated particles to form second aggregated particles,
wherein in the coalescing, a dispersion containing the second aggregated particles is heated and the second aggregated particles are coalesced to form toner particles.

19. An electrostatic charge image developing toner which is prepared by the preparing method of an electrostatic charge image developing toner according to claim 1.

20. An electrostatic charge image developer comprising an electrostatic charge image developing toner which is prepared by the preparing method of an electrostatic charge image developing toner according to claim 1.
